(19) United States
(12) Patent Application Publication
(10) Pub. No.: US 2026/0023406 A1
(43) Pub. Date: Jan. 22, 2026

(54) DISPLAY DEVICE

(71) Applicant: LG ELECTRONICS INC., Seoul (KR)

(72) Inventors: Bin LEE, Seoul (KR); Sunghwan KIM, Seoul (KR)

(73) Assignee: LG ELECTRONICS INC., Seoul (KR)

(21) Appl. No.: 18/988,509

(22) Filed: Dec. 19, 2024

(30) Foreign Application Priority Data
Jul. 16, 2024 (WO) PCT/KR2024/010172

(51) Int. Cl. G06F 1/16; G06F 1/20; H04R 1/02

(52) U.S. Cl. CPC G06F 1/1605; G06F 1/206; H04R 1/025; H04R 2499/15

(57) ABSTRACT

A display device including a display unit; a cover coupled to a back surface of the display unit; a circuit board mounted on a first surface area of the cover; and a speaker module mounted on a second surface area the cover. Further, the speaker module includes a speaker unit configured to output sound via a vibrating diaphragm generating sound pressure; and a speaker case including a mounting portion on which the speaker unit is mounted, and a sound pressure passage having a first end receiving the generated sound pressure from the vibrating diaphragm of the speaker unit and a second end extending to a first side of the speaker module facing the circuit board.

### CROSS-REFERENCE TO RELATED APPLICATIONS

This application claims priority to PCT Application No. PCT/KR2024/010172, filed on Jul. 16, 2024, the entire contents of which is hereby expressly incorporated by reference into the present application.

### BACKGROUND

### Field of the Disclosure

The present disclosure relates to a display device with improved heat dissipation efficiency.

### Discussion of the Related Art

With growth of information society, demand for various display devices has increased. In order to satisfy such demand, in recent years, a liquid crystal display (LCD), a field emission display (FED), a plasma display panel (PDP), and an electroluminescent device have been developed as display devices. A liquid crystal panel of the liquid crystal display includes a liquid crystal layer and a TFT substrate and a color filter substrate opposite each other in the state in which the liquid crystal layer is interposed therebetween, wherein a picture is displayed using light provided from a backlight unit.

An active matrix type organic light-emitting display has come onto the market as an example of the electroluminescent device. Since the organic light-emitting display is self-emissive, the organic light-emitting display has no backlight, compared to the liquid crystal display, and has merits in terms of response time and viewing angle, and therefore the organic light-emitting display has attracted attention as a next-generation display. When the organic light-emitting display is used as a display panel, the organic light-emitting display itself is made of a flexible material, the rigidity of a module cover supporting the organic light-emitting display is important.

As display devices become thinner, electronic components are packed tightly into an internal space and an internal space is narrow, and thus there are problems with heat dissipation reliability. There is an increasing need to increase heat dissipation efficiency by adding a heat dissipation member or improving the existing structure to improve heat dissipation efficiency in display devices.

### SUMMARY

The present disclosure can improve the heat dissipation efficiency of a display device by using a speaker module to resolve the above problems.

A display device includes a display unit, a cover bottom coupled to a back surface of the display unit, a circuit board mounted on a back surface of the cover bottom, and a speaker module mounted on the back surface of the cover bottom and having one side adjacent to the circuit board, wherein the speaker module includes a speaker unit configured to output sound, and a speaker case including a unit mounting portion on which the speaker unit is mounted, and a speaker case including a sound pressure passage having one end adjacent to the unit mounting portion and another end extending to one side of the speaker module.

The sound pressure passage can have one end having a wider width than another end.

One end of the sound pressure passage can have a size that is three to six times larger than another end.

Another side of the speaker module includes a sound hole that is open at a position corresponding to the unit mounting portion.

The other side of the speaker module can be located at a lower end of the display device.

A side wall portion of the sound pressure passage can include a curved edge formed at an inlet or an outlet.

The speaker module can include a front case coupled to the cover bottom and a rear case coupled at a rear side of the front case to form a sound space, a back surface of the speaker unit can be mounted to be in contact with a back surface of the unit mounting portion, and the sound pressure passage can be formed in the front case.

The display device can further include a reinforcing rib having a lattice shape and protruding on a back surface of the front case, and the reinforcing rib can be omitted at a portion in which the sound pressure passage is located.

A thickness in a front-back direction of the sound pressure passage can be less than or equal to a thickness of the reinforcing rib.

A thickness in a front-back direction of the sound pressure passage can be less than a thickness in a front-back direction of the unit mounting portion.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a front perspective view illustrating an example of a display device according to the present disclosure.

FIG. 2 is a rear view of a display device according to the present disclosure with a back cover removed.

FIG. 3 is a rear view showing a front case of a speaker of a display device of the present disclosure.

FIG. 4 is a rear view showing a rear case of a speaker module of a display device of the present disclosure.

FIG. 5 is a cross-sectional perspective view of a sound pressure passage of a speaker module of a display device according to the present disclosure.

FIG. 6 is a cross-sectional exploded perspective view of a sound pressure passage of a speaker module of a display device according to the present disclosure.

### DETAILED DESCRIPTION

Description will now be given in detail according to exemplary embodiments disclosed herein, with reference to the accompanying drawings. For the sake of brief description with reference to the drawings, the same or equivalent components can be provided with the same reference numbers, and description thereof will not be repeated. In general, a suffix such as “module” and “unit” can be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, etc. can be used herein to describe various elements, these elements are not limited by these terms. These terms are generally only used to distinguish one element from another.

When an element is referred to as being “connected with” another element, the element can be directly connected with the other element or intervening elements can also be present. In contrast, when an element is referred to as being “directly connected with” another element, there are no intervening elements present.

A singular representation can include a plural representation unless it represents a definitely different meaning from the context. Terms such as “include” or “has” are used herein and are intended to indicate an existence of several components, functions or steps, disclosed in the specification, and greater or fewer components, functions, or steps can likewise be utilized.

Meanwhile, an image display device 100 described in this specification is, for example, an intelligent or smart image display device 100 having a computer supporting function in addition to a broadcast reception function, wherein an Internet function can be added while the broadcast reception function is performed, whereby an interface that is more conveniently used, such as a handwriting type input device, a touchscreen, or a space remote control, is provided. In addition, the image display device can be connected to the Internet or a computer through support of a wired or wireless Internet function, whereby various functions, such as e-mail, web browsing, banking, or gaming, can be executed. For such various functions, a standardized general-purpose OS can be used.

In the image display device described in the present disclosure, therefore, various applications can be freely added or deleted, for example, on a general-purpose OS kernel, whereby various user friendly functions can be executed. More specifically, the image display device can be a network TV, an Hbb TV, or a smart TV, and is applicable to a smartphone depending on circumstances.

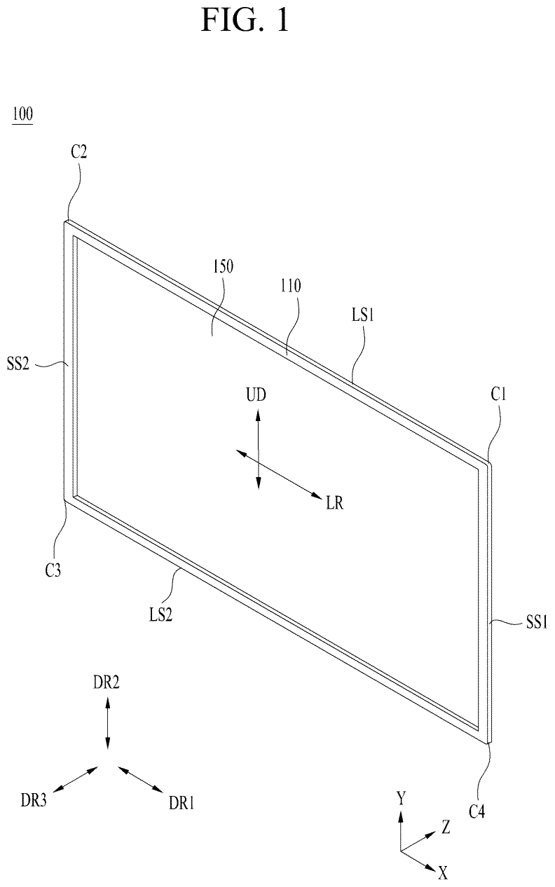

In more detail, FIG. 1 is a front perspective view illustrating an example of a display device 100 according to an embodiment of the present disclosure. As shown, the display device 100 includes a display unit 150 that occupies most of a front surface area, a case top 110 that covers a front perimeter and side surfaces of the display unit 150, and a cover bottom (rear surface cover) 120 that covers a rear surface of the display unit 150.

In addition, as shown in FIG. 1, the display device 100 according to an embodiment of the present disclosure can have a rectangular body including a pair of long sides and a pair of short sides. In particular, the display device 100 can include a first long side LS1, a second long side LS2 opposing the first long side LS1, a first short side SS1 adjacent to the first long side LS1 and the second long side LS2, and a second short side SS2 opposing the first short side SS1. As shown, the long side extending horizontally and the short side extending vertically are illustrated in the drawing, but the long side and the short side can be of equal length, and the long side can also be arranged vertically.

For convenience of explanation, the following description is based on an example in which a side extending in a horizontal direction (x-axis direction) is a long side and a side extending in a vertical direction (y-axis direction) is a short side, but, as mentioned above, the present disclosure is not limited thereto. As shown in FIG. 1, a first direction DR1 can be a direction parallel to the long sides LS1 and LS2 of the display device 100, a second direction DR2 can be a direction parallel to the short sides SSI and SS2 of the display device 100, and a third direction DR3 can be a direction perpendicular to the first direction DR1 and/or the second direction DR2.

A side toward which the display device 100 displays an image can be referred to as a forward direction or a front side or front surface. When the display device 100 displays an image, a side at which the image is not observed can be referred to as a rearward direction, a rear side, rear surface, backside, etc. When a display device displays an image, the side at which the image is not observed can be referred to as a rearward direction, a rear side, rear surface, backside, etc.

When viewing a display from the forward direction or front side or surface, the first long side LS1 can be referred to as an upper side or an upper surface. In addition, the second long side LS2 can be referred to as a lower side or a lower surface, the first short side SS1 can be referred to as a right side or a right surface, and the second short side SS2 can be referred to as a left side or a left surface.

In addition, as shown in FIG. 1, the display device includes the display unit 150. The display unit 150 may generate a driving signal by converting an image signal, data signal, OSD signal, control signal, and the like, which are processed by a controller or an image signal, data signal, control signal, and the like, which are received from an interface unit.

Further, the display unit 150 can include a display panel having a plurality of pixels including RGB sub-pixels or RGBW sub-pixels. The display unit 150 can convert the image signal, data signal, OSD signal, control signal, and the like, which are processed by the controller to generate driving signals for the pixels.

In addition, the display device 100 includes the display unit 150 that occupies most of the front surface area and a case that covers a back side and lateral side of the display unit 150 and packages the display unit 150. The display unit 150 can be a plasma display panel (PDP), a liquid crystal display (LCD), an organic light emitting diode (OLED), a flexible display, or the like and can also be a 3D display. In particular, the 3D display unit 150 can be divided into a non-glasses type and a glasses type. Recently, the display device 100 can use a flexible display unit 150 such as a light emitting diode (LED) or an organic light emitting diode (OLED) to implement a curved screen rather than a flat screen.

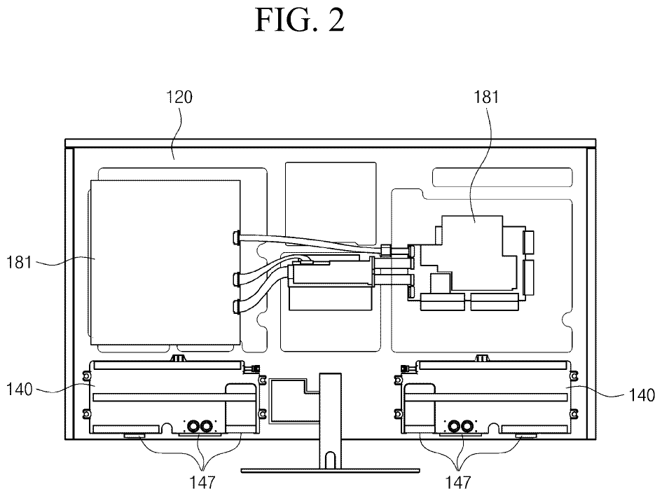

Next, FIG. 2 is a rear view of the display device 100 according to the present disclosure with a back cover removed. The display device 100 in FIG. 2 includes the display unit 150 that outputs an image and the cover bottom (rear surface cover) 120 covering a back of the display unit 150. The cover 120 also has a surface for mounting a power supply, a circuit board 181 controlling the display device 100, such as a T-con and a main board, and a speaker module 140.

As the display device 100 becomes thinner, a space for mounting electronic components on a back surface of the display unit 150 becomes narrower, resulting in a problem of reduced heat dissipation efficiency. To improve a heat dissipation effect, a heat sink or heat dissipation fin with high thermal conductivity can be added, but there is a problem in that the number of members increases, which increases the manufacturing cost and increases the size and weight of the product.

Accordingly, the display device 100 according to an embodiment of the present disclosure can advantageously discharge heat generated from the circuit board 181 mounted on the back surface of the display unit 150 by using wind or air movement generated by sound pressure output from the speaker module 140. When a sound hole 147 of the speaker module 140 is located laterally, the sound hole 147 can be exposed or to face to a user viewing the display device 100. As shown in FIG. 2, the speaker module 140 can be located at a lower side of the display device 100 so the sound hole 147 is placed at the bottom.

In addition, as shown in FIG. 2, speaker modules 140 can be located in pairs on the left and right to thus output a balanced sound, and the circuit board 181 (e.g., a power supply unit, T-con, and main board) can be mounted on an upper side of the speaker module 140. Further, as shown, the speaker module 140 and the circuit board 181 can be located adjacent to each other. In more detail, the speaker module 140 and the circuit board 181 can be located in upward and downward directions as shown in FIG. 2. However, when the speaker module 140 is located at a lateral side of the display device 100, the circuit board 181 can also be located at a central side of the display device 100.

For convenience of explanation, a direction facing the circuit board 181 is referred to as one side of the speaker module 140, and the opposite direction is referred to as the other side. In the present embodiment, one side of the speaker module 140 means an upper side, and the other side of the speaker module 140 means a lower side.

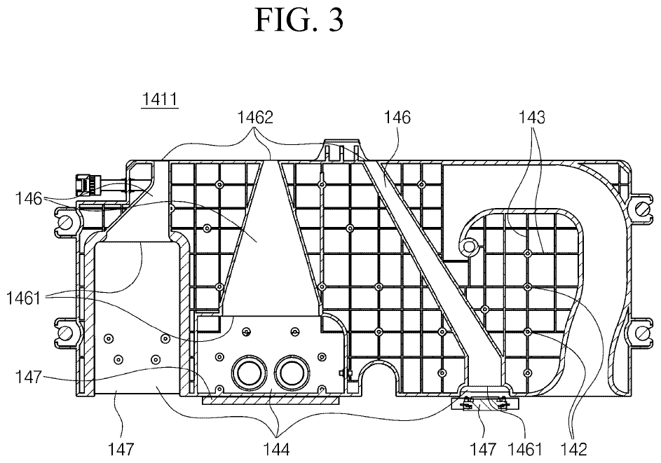

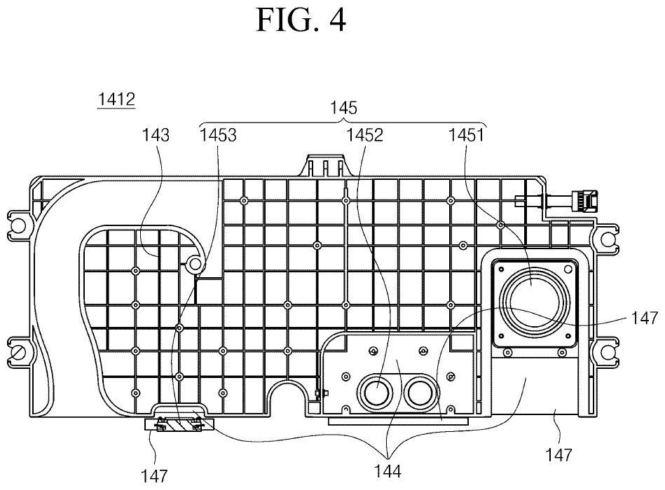

Next, FIG. 3 is a rear view illustrating a front case 1411 of the speaker module 140, and FIG. 4 is a front view illustrating a rear case 1412 of the speaker module 140 according to an embodiment of the present disclosure. In addition, as shown in FIG. 4, the speaker module 140 can include a plurality of speaker units 145 having different characteristics. For example, the speaker module 140 can include a woofer 1451 that outputs low-range sounds, a tweeter 1453 that outputs high-range sounds, and a mid-range 1452 that is optimized to output a sound range therebetween.

The woofer 1451 and the mid-range 1452 can be located facing a front surface, i.e., a back surface of the display unit 150, and the tweeter 1453 that outputs high-frequency sound can be located facing the lower side of the display device 100 due to its strong straightness. In addition, speaker module 140 can include speaker cases 1411 and 1412 in which the plurality of speaker units 145 are stored. The display device 100 according to the present disclosure can have a small thickness, and thus the speaker module 140 can also be stored in a thin, square box-shaped speaker cases 1411 and 1412.

Each speaker case can include a unit mounting portion 144 on which each speaker unit 145 is mounted, and the unit mounting portions 144 can have different shapes and sizes depending on the size of the speaker unit 145. The woofer 1451 and the mid-range 1452 are located toward the front surface, and thus the front case 1411 can be combined after rear surfaces of the woofer 1451 and the mid-range 1452 are located to come in contact with the unit mounting portion 144 formed in the rear case 1412. The tweeter 1453 can be assembled to face the lower side of the speaker cases 1411 and 1412.

A low-frequency sound output from the woofer 1451 does not have a large directionality, but the mid-range 1452 or the tweeter 1453 can be located toward the lower side of the display device 100 in which the sound hole 147 is located to effectively transmit sound to a user. The speaker unit 145 mounted on the speaker module 140 can face the outside of the display device 100, and the circuit board 181 can be mounted on an opposite side. Accordingly, the speaker unit 145 can be located on the other side of the speaker module 140.

As shown in FIGS. 3 and 4, the speaker cases 1411 and 1412 can include a reinforcing rib 143 having a rigid protruding lattice shape, and a reinforcing rib 1431 of the front case 1411 and a reinforcing rib 1432 of the rear case 1412 can be spaced apart except for a case fastening portion 142 to implement a sound box (enclosure). In addition, the speaker module 140 according to an embodiment of the present disclosure includes a sound pressure passage 146 to dissipate heat from the circuit board 181 by using sound pressure generated when sound is output from the speaker unit 145. The sound pressure passage 146 can extend from the unit mounting portion 144 of the speaker module 140 toward one side of the speaker module 140 toward the circuit board 181.

As shown in FIG. 3, one end of the sound pressure passage 146 is connected to the unit mounting portion 144 located at the lower side of the speaker module 140 and extends toward the upper side. Thus, the sound pressure generated when sound is output from the speaker unit 145 can be supplied to the circuit board 181 located at upper side of the speaker module 140 through the sound pressure passage 146.

Further, the woofer 1451 and the mid-range 1452 of the speaker unit 145 output sound toward the front case 1411, and thus a direction of the sound pressure is also a forward direction. Accordingly, the sound pressure passage 146 can be formed in the front case 1411 such that the sound pressure passage 146 is connected from the front side in a thickness direction of the unit mounting portion 144.

A faster speed of air passing through the sound pressure passage 146 is preferable to supply stronger wind or air pressure and movement towards the circuit board 181. Thus, the other end 1462 of the sound pressure passage 146 facing the circuit board 181 can be formed narrower than one end 1461 (inlet) of the sound pressure passage 146 connected to the unit mounting portion 144. Also, the width of the inlet 1461 of the sound pressure passage 146 can be equal to or smaller than a width of the unit mounting portion 144, and can be configured to have a size that is 3 to 6 times larger than the width of the other end (outlet) 1462 of the sound pressure passage.

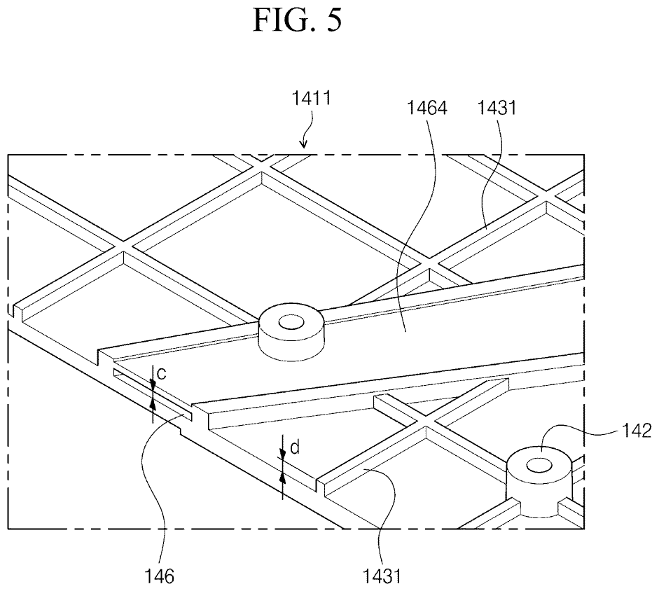

Next, FIG. 5 illustrates a cross section of the sound pressure passage 146 of a speaker module of a display device according to an embodiment of the present disclosure. When a cross sectional area of the sound pressure passage 146 is excessively large, the strength of wind, air movement or air pressure supplied to the circuit board 181 becomes weak. Therefore, to pass or push air through the sound pressure passage 146 at a high pressure, a thickness “c” in a front-back direction of the sound pressure passage 146 can have a thin thickness of 1 mm or less. In more detail, the thickness c of the sound pressure passage 146 can be smaller than the thickness of the speaker module 140 and have a thickness less than or equal to a thickness “d” of the reinforcing rib 143 of the front case 1411 described above.

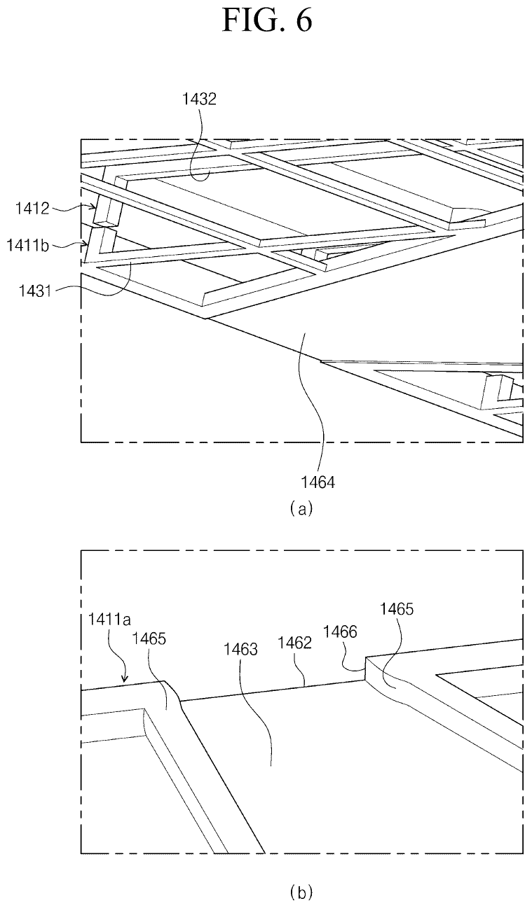

Next, FIG. 6 is a cross-sectional perspective view of the speaker module 140 of the display device 100 according to the present disclosure. As a cross-section corresponding to the rear surface of the sound pressure passage 146, FIG. 6(a) illustrates the rear case 1412 and a portion 1411b of a front case including a rear portion 1464 of the sound pressure passage 146, and FIG. 6(b) illustrates a portion 1411a of the front case including a front portion 1463 of the sound pressure passage 146.

As shown in FIG. 5, a thickness “c” of the sound pressure passage 146 can be formed to a thickness corresponding to or thinner than the reinforcing rib 143 of the front case 1411 to minimize the influence on the function of the sound box of the speaker cases 1411 and 1412. As shown in FIG. 6(b), the inlet 1461 and an outlet 1462 of the sound pressure passage 146 can include a curved portion 1466 at a corner of a side wall portion 1465 to prevent the speed of air passing through the sound pressure passage 146 from being reduced by an impeded flow of air caused by an unsmooth or non-curved portion.

As described above, the display device 100 according to an embodiment of the present disclosure can improve heat dissipation efficiency by using existing components. In addition, the number of other heat dissipation members can be reduced, which can reduce material costs and improve product quality through production management and reduction of defective materials.

The above detailed description should not be construed as being limitative in all terms, but should be considered as being illustrative. The scope of the present disclosure should be determined by reasonable analysis of the accompanying claims, and all changes in the equivalent range of the present disclosure are included in the scope of the present disclosure.

The present disclosure improves heat dissipation efficiency of a display device by using existing components. In addition, the number of other heat dissipation members can be reduced, which reduces material costs and improves product quality through production management and reduction of defective materials.

Effects obtainable from the present disclosure are not limited by the above mentioned effects, and other unmentioned effects can be clearly understood from the above description by those having ordinary skill in the technical field to which the present disclosure pertains.

What is claimed is:

1. A display device comprising:
a display unit;
a cover coupled to a back surface of the display unit;
a circuit board mounted on a first surface area of the cover; and
a speaker module mounted on a second surface area the cover,
wherein the speaker module includes:
a speaker unit configured to output sound via a vibrating diaphragm generating sound pressure; and
a speaker case including a mounting portion on which the speaker unit is mounted, and a sound pressure passage having a first end receiving the generated sound pressure from the vibrating diaphragm of the speaker unit and a second end extending to a first side of the speaker module facing the circuit board.

2. The display device of claim 1, wherein the first end of the sound pressure passage has a wider width than the second end of the sound pressure passage.

3. The display device of claim 2, wherein the first end of the sound pressure passage has a size that is three to six times larger than the second end of the sound pressure passage.

4. The display device of claim 1, wherein a second side of the speaker module opposite to the first side includes a sound opening for outputting the sound output by the speaker unit.

5. The display device of claim 4, wherein the second side of the speaker module is located at a lower end of the display device.

6. The display device of claim 1, wherein a side wall portion of the sound pressure passage includes a smooth curved edge formed at an inlet or an outlet of the sound pressure passage.

7. The display device of claim 1, wherein the speaker module further includes:
a front case coupled to the cover and a rear case coupled at a rear side of the front case to form a sound space,
wherein a back surface of the speaker unit is mounted in contact with a back surface of the mounting portion, and
wherein the sound pressure passage is formed in the front case.

8. The display device of claim 7, wherein the front case includes a lattice shaped protruding reinforcing rib at portions excluding where the sound pressure passage is located.

9. The display device of claim 8, wherein a thickness in a front-back direction of the sound pressure passage is less than or equal to a thickness of the lattice shaped protruding reinforcing rib.

10. The display device of claim 1, wherein a thickness in a front-back direction of the sound pressure passage is less than a thickness in a front-back direction of the mounting portion.

11. The display device of claim 1, wherein the speaker unit comprises:
a first speaker;
a second speaker; and
a third speaker.

12. The display device of claim 11, wherein the first speaker is a tweeter speaker, the second speaker is a mid-range speaker, and the third speaker is a woofer speaker.

13. The display device of claim 12, wherein the sound pressure passage comprises:
a first sound pressure passage extending from the tweeter speaker to the first side of the speaker module;
a second sound pressure passage extending from the mid-range speaker to the first side of the speaker module; and
a third sound pressure passage extending from the woofer speaker to the first side of the speaker module.

14. The display device of claim 13, wherein first sound pressure passage is longer in length than the third sound pressure passage.

15. The display device of claim 1, wherein the sound pressure passage extends at an angle from the second side of the speaker module to the first side of the speaker module facing the circuit board.

16. The display device of claim 15, wherein the sound pressure passage extends perpendicularly from the second end of the speaker module and extends at the angle from the perpendicularly extending sound pressure passage to the first side of the speaker module facing the circuit board.

17. The display device of claim 16, wherein the speaker module further includes:
a front case coupled to the cover; and
a rear case coupled at a rear side of the front case, and
wherein the front case includes a first lattice shaped protruding reinforcing rib on a back surface of the front case at portions excluding where the sound pressure passage is located.

18. The display device of claim 17, wherein the rear case includes a second lattice shaped protruding reinforcing rib at portions including where the sound pressure passage is located and at portions where the sound pressure passage is not located.

19. The display device of claim 18, wherein the first and second lattice shaped protruding reinforcing ribs include fastening portions for mounting the front case to the rear case.

20. The display device of claim 1, wherein the circuit board includes a first circuit board mounted on an upper first corner portion of the cover, and a second circuit board mounted on an upper second corner portion of the cover,
wherein speaker module includes a includes a first speaker module mounted on a lower first corner portion of the cover, and a second speaker module mounted on a lower second corner portion of the cover, and
wherein the first circuit board faces the first speaker module, and the second circuit board faces the second speaker module.
